(19) United States
(12) Patent Application Publication
(10) Pub. No.: US 2018/0216583 A1
(43) Pub. Date: Aug. 2, 2018

(54) INTERNAL COMBUSTION ENGINE FOR A MOTOR VEHICLE

(71) Applicant: Mahle International GmbH, Stuttgart (DE)

(72) Inventors: Sascha Naujoks, Pfinztal (DE); Simon Streng, Stuttgart (DE); Peter Wieske, Korntal-Muenchingen (DE)

(21) Appl. No.: 15/883,019

(22) Filed: Jan. 29, 2018

(30) Foreign Application Priority Data
Feb. 1, 2017 (DE) 102017201609.4

(51) Int. Cl. F02M 27/02; F02M 31/20; F02M 31/18; F01N 3/02; F02M 26/20; C10L 1/04; C10G 35/04; B60H 1/32

(52) U.S. Cl. CPC F02M 27/02; F02M 31/20; F02M 31/18; F01N 3/0205; C10L 2270/02; C10L 1/04; C10G 35/04; B60H 1/32; F02M 26/20

(57) ABSTRACT

An internal combustion engine for a motor vehicle may include at least one cylinder including a combustion chamber for combusting a fuel-air mixture introduced into the combustion chamber. The engine may also include at least one fuel injector and a fresh air feed. The engine may further include an exhaust gas discharge for discharging exhaust gas from the combustion chamber and an exhaust gas recirculation for recirculating the discharged exhaust gas into the combustion chamber. Additionally, the engine may include a heat exchanger arranged in the exhaust gas recirculation, the heat exchanger may include at least one first fluid path and at least one second fluid path. A knock number of the fuel may be increased when the fuel flows through the heat exchanger. The at least one second fluid path may fluidically communicate with the at least one fuel injector.

### CROSS-REFERENCE TO RELATED APPLICATIONS

This application claims priority to German Patent Application No. DE 10 2017 201 609.4, filed on Feb. 1, 2017, the contents of which are hereby incorporated by reference in its entirety.

### TECHNICAL FIELD

The present invention relates to an internal combustion engine for a motor vehicle and to a motor vehicle having such an internal combustion engine.

### BACKGROUND

Conventional internal combustion engines are generally equipped with an exhaust gas recirculation for reducing the emission of nitrogen oxides generated during the combustion of fuel in spark-ignition engines and also diesel engines.

During the combustion of the fuel-air mixture introduced into the combustion chambers of the internal combustion engine, hydrocarbon molecules of the fuel employed are oxidised with oxygen. The oxygen introduced into the combustion chamber is almost or even completely consumed in the process, so that almost no oxygen molecules are present in the exhaust gas any longer. When exhaust gas is now admixed with the fresh air introduced into the combustion chambers, the oxygen concentration of the mixture of fresh air and exhaust gas drops. However, in order to completely combust the fuel injected into the combustion chambers despite this, less fuel is injected in modern internal combustion engines because of the lower oxygen concentration so that the overall fuel consumption of the internal combustion engine decreases.

Regardless of the advantage of a reduced fuel consumption explained above, which can be achieved by means of exhaust gas recirculation, using a fuel with as high as possible a knock resistance in the internal combustion engine additionally proves to be advantageous, in particular when the internal combustion engine is a spark-ignition engine. In this way it can be prevented that through simultaneous explosion of a large part of the fuel-air mixture in the combustion chamber concerned—this effect is known to the person skilled in the art by the term “knocking”—the sliding bearings and other components of the internal combustion engine that are sensitive to wear are exposed to undesirably high loading.

### SUMMARY

It is therefore an object of the present invention to create an improved embodiment for an internal combustion engine which is characterized by a low fuel consumption and good wear characteristics.

According to the invention, this problem is solved through the subjects of the independent claim(s). Advantageous embodiments are subject of the dependent claims.

Accordingly, the fundamental idea of the invention is to equip an internal combustion engine with an exhaust gas recirculation and utilise this exhaust gas recirculation for chemically converting liquid fuel which is to be injected into the combustion chambers of the internal combustion engine in such a manner that the knock resistance of said fuel is increased prior to the injection into the combustion chambers. According to the invention it is proposed for this purpose to integrate a heat exchanger in said exhaust gas recirculation which is designed as a catalytic fuel evaporator. This means that for increasing the knock number the fuel is introduced into said heat exchanger and that chemical oxidation reactions occur in the heat exchanger, by way of which the long-chain hydrocarbons contained in the fuel are converted into shorter-chain hydrocarbons. This conversion is accompanied by the desired increase of the knock number of the fuel. In order to trigger said oxidation reactions for converting the fuel the temperature of the fuel has to exceed a certain temperature level. For this purpose, heat is extracted from the exhaust gas conducted through the heat exchanger and transferred to the fuel as a result of which the temperature of said fuel can be increased to said temperature level or beyond. This temperature increase is typically accompanied by an evaporation of the originally liquid fuel. The fuel imparted with an elevated knock number in this way can be subsequently injected into the combustion chambers of the internal combustion engine.

In this way, excessive “knocking” during the igniting of the fuel-air mixture can be avoided or compared with fuel with non-elevated knock number, significantly reduced. This is accompanied by an improved wear resistance of the internal combustion engine.

An internal combustion engine according to the invention comprises at least one cylinder having a combustion chamber for combusting a fuel-air mixture introduced into the at least one combustion chamber. For each combustion chamber present in the internal combustion engine, at least one fuel injector for injecting fuel into the respective combustion chamber is provided. Furthermore, a fresh air feed for feeding fresh air into the combustion chamber concerned is provided. Furthermore, an exhaust gas discharge for discharging exhaust gas generated in the combustion chamber from the combustion chamber is provided. Apart from this, the internal combustion engine comprises an exhaust gas recirculation which for recirculating exhaust gas discharged from the combustion chamber fluidically communicates with the fresh air feed and the exhaust gas discharge. In the exhaust gas recirculation a heat exchanger is arranged which comprises at least one first fluid path, which is part of the exhaust gas recirculation and which is flowed through by the exhaust gas to be recirculated. According to the invention, the heat exchanger additionally comprises a second fluid path which, fluidically separately from the first fluid path, is flowed through by a fuel the knock number of which is increased when flowing through the heat exchanger. In the process, the at least one second fluid path of the heat exchanger fluidically communicates with at least one fuel injector for introducing the fuel with elevated knock number into the at least one combustion chamber.

According to a preferred embodiment, the heat exchanger is designed as catalytic fuel evaporator for chemically converting the fuel flowing through the at least one second fluid path. This means that the heat exchanger acts as catalytic converter during the oxidation of the hydrocarbons contained in the fuel. In the process, the fuel contained in the exhaust gas is evaporated. The temperature level in the fuel required for the oxidation reaction is achieved in the heat exchanger by transferring heat from the exhaust gas to be recirculated to the fuel to be converted. By means of the further development explained above, the knock resistance of the fuel converted in the fuel evaporator can be easily increased.

Particularly preferably, a catalytic coating is provided in the at least one second fluid path. In this way, the catalytic converters required for carrying out the oxidation reactions can be provided.

Practically, the heat exchanger is designed for converting long-chain hydrocarbons contained in the fuel into short-chain hydrocarbons.

Particularly preferably, the fuel evaporator can be designed for converting the hydrocarbon compound C₈H₁₈ into the hydrocarbon compound C₃H₈. In versions, however, other hydrogen compounds can also be converted by a suitable design of the fuel evaporator.

Particularly practically, the fuel evaporator is designed in such a manner that the knock number of the fuel is increased by 2 RON after the conversion of the hydrocarbon chains.

According to a preferred embodiment, a fuel cooler for cooling, preferentially for liquefying, the fuel exiting the heat exchanger is arranged between the at least one second fluid path of the heat exchanger for converting the fuel and the at least one fuel injector of the internal combustion engine. This permits an advantageous adaptation of the temperature of the fuel with elevated knock number to the fuel temperature of the fuel which is to be directly injected into the combustion chambers from the fuel tank of the motor vehicle using the internal combustion engine.

Practically, the fuel cooler can also be designed as heat exchanger which is flowed through by the fuel to be cooled and, fluidically separated from this fuel, by a coolant, which in this heat exchanger, for cooling the mixture of exhaust gas and fuel, is thermally coupled to the same. Such heat exchangers are commercially available in manifold technical forms of realisation and particularly easily and thus also cost-effectively integratable in the exhaust gas recirculation. Conceivable, in particular, is the technical realisation of such a heat exchanger as stacked plate heat exchanger, in particular as so-called finned-tube heat exchanger.

According to another preferred embodiment, an exhaust gas cooler for cooling the exhaust gas exiting the heat exchanger is arranged between the at least one first fluid path of the heat exchanger and the fresh air feed. In this way, the temperature of the exhaust gas to be recirculated can be reduced before it is again introduced into the combustion chambers of the internal combustion engine via the fresh air feed.

In an advantageous further development, the exhaust gas cooler is also designed as heat exchanger which is flowed through by the exhaust gas to be cooled and, fluidically separated from the exhaust gas, by a coolant. On flowing through this heat exchanger, the coolant for cooling is thermally coupled to the exhaust gas so that this heat can be transferred to the coolant. Such heat exchangers are commercially available in manifold technical forms of realisation and particularly easily and thus also cost-effectively integratable in the exhaust gas recirculation. Conceivable in particular is the technical realisation of such a heat exchanger as stacked-plate heat exchanger, in particular as so-called finned-tube heat exchanger.

Particularly preferably, the internal combustion engine equipped with the exhaust gas recirculation and the fuel evaporator can be designed as spark-ignition engine.

The invention, furthermore, relates to a motor vehicle having an internal combustion engine introduced above. The advantages of the internal combustion engine explained above therefore apply also to the motor vehicle according to the invention.

In an advantageous further development, the motor vehicle comprises a refrigeration system with a refrigeration circuit flowed through by a refrigerant. In this further development, the fuel cooler and/or the exhaust gas cooler are incorporated in the refrigeration circuit of the refrigeration system, so that the refrigerant functions as coolant for the fuel flowing through the fuel cooler or for the exhaust gas flowing through the exhaust gas cooler.

Practically, the refrigeration system can be part of an air conditioning system present in the motor vehicle for air conditioning the vehicle interior of the motor vehicle. Providing a separate refrigeration system is not required in this scenario, which is accompanied by substantial cost advantages.

Further important features and advantages of the invention are obtained from the subclaims from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description.

### BRIEF DESCRIPTION OF THE DRAWINGS

The drawings show:

FIG. 1 an example of an internal combustion engine according to the invention,

FIG. 2 the fuel evaporator arranged in the exhaust gas recirculation of the internal combustion engine that is substantial for the invention in a separate schematic representation.

### DETAILED DESCRIPTION

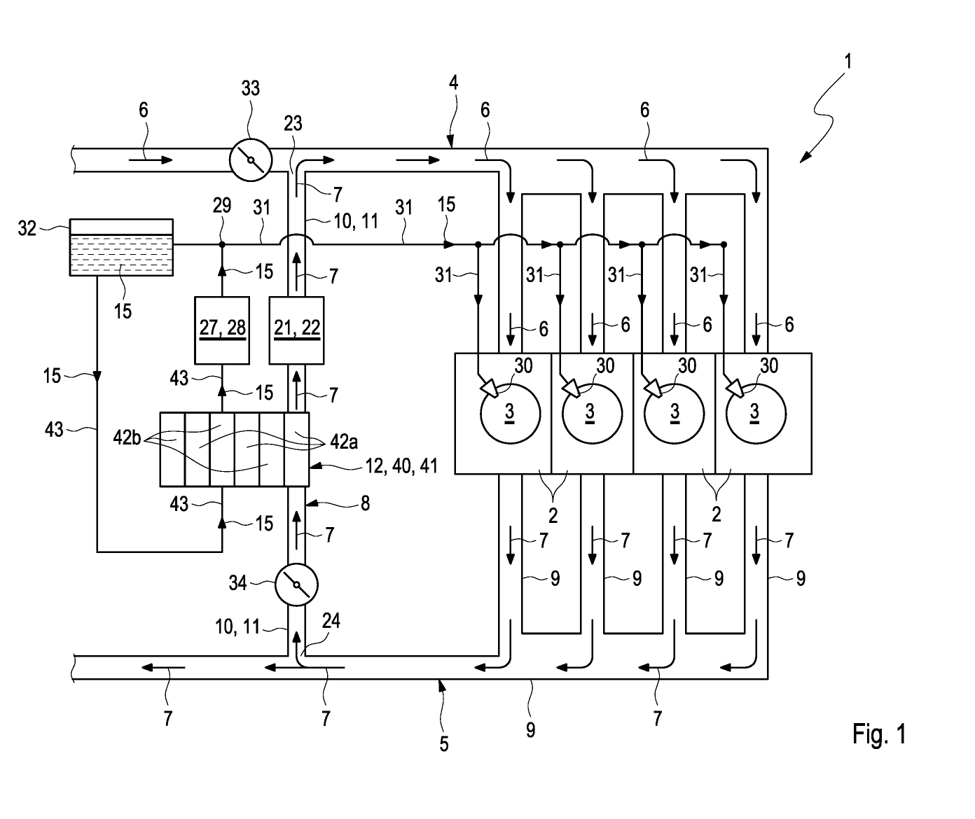

In a schematic representation, FIG. 1 illustrates an example of an internal combustion engine 1 according to the invention, which can be embodied as spark-ignition engine. In the example of FIG. 1, the internal combustion engine 1 is realised as four-cylinder engine and accordingly comprises four cylinders 2, in which in each case a combustion chamber 3 for combusting a fuel-air mixture introduced into the respective combustion chamber 3 is present. It is to be understood that in versions of the example, a different number of cylinders 2 and thus also a different number of combustion chambers 3 can be provided.

For each combustion chamber 3, a respective fuel injector 3 for injecting fuel 15 into the combustion chamber 3 concerned is provided in the internal combustion engine 1. The fuel injectors 30 communicate via fuel lines 31 with a fuel reservoir 32 which is only schematically represented in the figures, from which the fuel injectors 30 are supplied with fuel 15. Typically, the fuel reservoir 32 is a fuel tank of the vehicle equipped with the internal combustion engine 1 according to the invention.

Furthermore, the internal combustion engine 1 comprises a fresh air feed 4 for feeding fresh air 6 into the combustion chambers 3 of the cylinders 2. The fresh air feed 4 can be part of a fresh air system of the internal combustion engine 1 which is not shown in more detail in the figures. Feeding fresh air 6 into the combustion chambers 3 can be controlled with the help of a valve device 33 arranged in the fresh air feed 4. Furthermore, the internal combustion engine 1 comprises an exhaust gas discharge 5 for discharging exhaust gas 7 generated in the combustion chambers 3 of the cylinders 2 by combustion of the fuel-air mixture. The exhaust gas discharge 5 can be part of an exhaust system which is not shown in more detail in the figures, which discharges the exhaust gas 7 from the combustion chambers 3 via individual exhaust pipes 9 usually described as bends.

The internal combustion engine 1 also comprises an exhaust gas recirculation 8 for partly recirculating the exhaust gas 7 discharged from the cylinders 2 via the fresh air feed 4 into the combustion chambers 3 of the internal combustion engine 1. For this purpose, a branch 24 is provided in the exhaust gas discharge 5, in which the exhaust gas recirculation 8 branches off the exhaust gas discharge 5. A part of the exhaust gas 7 discharged from the cylinders 2 of the internal combustion engine 1 exits the exhaust gas discharge 5 in the branch 24 and is subsequently conducted through the exhaust gas recirculation 8. The exhaust gas recirculation 8 can comprise a recirculation line 10 which can be flowed through by the exhaust gas 7 to be recirculated and fluidically communicates with the fresh air feed 4 and the exhaust gas recirculation 8. The recirculation line 10 can be designed in the manner of a recirculation pipe 11 at least in sections. The recirculation of the exhaust gas 7 into the combustion chambers 3 can be controlled with the help of a valve device 34 arranged in the exhaust gas recirculation 8.

In the exhaust gas recirculation 8 a heat exchanger 40 is arranged, which can be designed as a conventional stacked-plate heat exchanger 41. The stacked-plate heat exchanger 41 comprises first and second fluid paths 42a, 42b which are arranged fluidically separated and alternately adjacent to one another in the stacked-plate heat exchanger 41. The construction of the stacked-plate heat exchanger 41 is only roughly schematically indicated in FIG. 1. The first fluid paths 42a are part of the exhaust gas recirculation 8 and for this purpose fluidically integrated in the recirculation line 10 or in the recirculation pipe 11. The first fluid paths 42a of the heat exchanger 40 are thus flowed through by the exhaust gas 7 to be recirculated.

The second fluid paths 42b are flowed through by fuel 15 fluidically separately from the first fluid paths 42a, which fuel 15 is drawn from the fuel reservoir 32 via a fuel feed line 43. The knock number of the fuel 15 is elevated in the heat exchanger 40 or in the stacked-plate heat exchanger 41. For this purpose, the second fluid paths 42b of the heat exchanger 40 are designed as catalytic fuel evaporator 12 for chemically converting the fuel 15 flowing through the second fluid paths 42b.

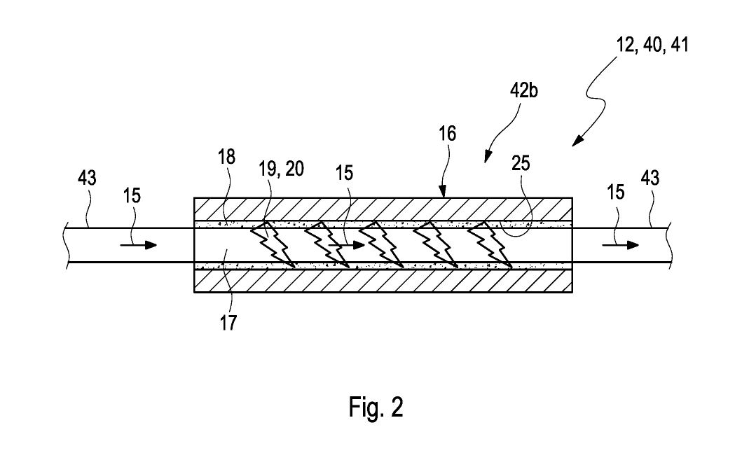

FIG. 2 shows a single second fluid path 42b of the heat exchanger 40 or of the stacked-plate heat exchanger 41, which is realised as fuel evaporator 12, in a separate representation. According to FIG. 2, each second fluid path 42b of the fuel evaporator 12 can comprise a respective tube body 16 by means of which the second fluid path 42b is incorporated in the fuel feed line 43. The tube body 16 delimits a tube body interior 17 that can be flowed through by the fuel 15. On an internal wall 25, in particular on an internal circumferential wall of the tube body 16, a catalytic coating 18 is present by means of which the long-chain hydrocarbons present in the fuel 15 are converted into shorter-chain hydrocarbons. For this purpose, oxidation reactions occur in the tube body interior 17 with the help of the catalytic coating 18. The temperatures required for the oxidation reactions to proceed are reached in the fuel 15 in that heat is extracted from the exhaust gas 7 flowing through the first fluid paths 42a and transferred to the fuel 15. In the process, the evaporation of the fuel 15 takes place. During the course of the evaporation of the fuel 15, the long-chain hydrocarbon compound C₈H₁₈ contained in the fuel 15 is converted by adding oxygen (O₂) as oxidant into the short-chain hydrocarbon compound C₃H₈, wherein carbon dioxide (CO₂) is liberated. The oxidation of the fuel 15 preferably takes place in the presence of severe air deficiency (λ<0.1).

In addition, the heat exchanger 40 or the fuel evaporator 12 can be equipped with an electric heating device 19. The electric heating device 19 then serves for heating the fuel 15 to be converted. The electric heating device 19 can be designed for example as electric heating coil 20 which is only roughly schematically indicated in FIG. 2, which is arranged in the tube body interior 17. With the help of the electric heating device 19, the temperature that is required for the oxidation reactions can be reached in the fuel 15 without the calorific value of the fuel 15 being reduced in the process. When the temperature of the fuel 15 to be converted is high enough for carrying out the oxidation reactions when entering the fuel evaporator 12 an additional heating of the fuel 15 by means of the electric heating device 19 can be dispensed with.

The gaseous fuel 15 with the short-chain hydrocarbon compounds C₃H₈ exiting the heat exchanger 40 or fuel evaporator 12 after the conversion has a higher knock resistance than the fuel 15 with the long-chain hydrocarbon compound C₈H₁₈ before entering the heat exchanger 40. In the example scenario, the octane or knock number is increased during the course of the conversion from RON 98 to a value of RON>=100.

On the outlet side, the second fluid paths 42b of the heat exchanger 40 fluidically communicate with the fuel injectors 30 for introducing the fuel 15 with elevated knock number into the combustion chambers 3 of the internal combustion engine 1. For this purpose, the second fluid paths 42b are connected to the fuel line 31 via which—as already explained above—fuel 15 from the fuel reservoir 32 is injected into the combustion chambers 3 without direct increase of the knock number.

In order to cool and liquefy the fuel 15 with elevated knock number before injection into the combustion chambers 3 a fuel cooler 27 for cooling or liquefying the fuel 15 exiting the heat exchanger 40 is arranged downstream of the heat exchanger 40, i.e. between the second fluid paths 42b of the heat exchanger 40 and the fuel injectors 30. The fuel cooler 27 can also be designed as heat exchanger 28 or comprise such a heat exchanger 28. Conceivable is a technical realisation of the heat exchanger 28 as so-called finned-tube heat exchanger or as conventional stacked-plate heat exchanger. Other technical forms of realisation are also known to the specific person skilled in the art. The heat exchanger 28 is flowed through by the fuel 15 to be cooled in the known manner.

Apart from this, the heat exchanger 28—fluidically separated from the fuel 15—is flowed through by a coolant which is not shown in more detail in FIG. 1. Within the heat exchanger 28, the coolant is thermally connected to the fuel 15 in the known manner for cooling the fuel 15. By transferring heat from the fuel 15 to the coolant, the temperature of the fuel 15 is reduced. In the process, the fuel 15 is liquefied. Having left the fuel cooler 27 designed as heat exchanger 28, the fuel 15 is introduced into the fuel line 31 with elevated knock number via a junction point 29 where—mixed with the fuel 15 with non-elevated knock number, which is directly taken from the fuel reservoir 32—it is introduced into the combustion chambers 3 via the fuel lines 31 and the fuel injectors 30.

In order to also cool the exhaust gas 7 prior to the intermixing with the fresh air 6 in the fresh air feed 4 and the renewed introduction of the exhaust gases 7 into the combustion chambers 3, an exhaust gas cooler 21 for cooling the exhaust gas 7 exiting the heat exchanger 40 is arranged in the exhaust gas recirculation 8 downstream of the heat exchanger 40, i.e. between the first fluid paths 42a of the heat exchanger 40 and the fresh air feed 4. In FIG. 1, the exhaust gas cooler 21 is only schematically indicated. The exhaust gas cooler 21 can also be designed as heat exchanger 22 or comprise such a heat exchanger 22. Conceivable is a technical realisation of the heat exchanger 22 as so-called finned-tube heat exchanger or as conventional stacked-plate heat exchanger. Other technical forms or realisation are also known to the specific person skilled in the art. In the known manner, the heat exchanger 22 is flowed through by the exhaust gas 7 to be cooled. Apart from this, the heat exchanger 22 is flowed through—fluidically separated from the exhaust gas 7 to be recirculated—by a coolant which is not shown in more detail in FIG. 1. Within the heat exchanger 22, the coolant is thermally coupled to the exhaust gas 7 in the known manner for cooling the exhaust gas 7. By transferring heat from the exhaust gas 7 to the coolant, the temperature of the exhaust gas 7 is reduced.

Having flowed through the exhaust gas cooler 21, the cooled exhaust gas 7 is discharged from the exhaust gas recirculation 8 via a branch 23 which opens into the fresh air feed 4 and together with fresh air 6 again introduced into the cylinders 2 of the internal combustion engine 1.

The internal combustion engine 1 introduced above can be optionally used in a motor vehicle which is equipped with a refrigeration system (not shown in the figures). Such a refrigeration system comprises a refrigeration circuit in which a refrigerant circulates (not shown). The refrigeration system can be part of an air conditioning system provided in the motor vehicle by means of which the vehicle interior of the motor vehicle is air conditioned. In the refrigeration circuit, the exhaust gas cooler 21 designed as heat exchanger 22 and, alternatively or additionally, the fuel cooler 27 designed as heat exchanger 28, can be incorporated. In the first case, the refrigerant of the refrigeration system serves as coolant for cooling the exhaust gas 7 flowing through the exhaust gas cooler 21. In the second case, the refrigerant of the refrigeration system serves as coolant for cooling the fuel 15 flowing through the fuel cooler 27.

1. An internal combustion engine for a motor vehicle, comprising:
at least one cylinder including a combustion chamber for combusting a fuel-air mixture introduced into the combustion chamber;
at least one fuel injector for injecting a fuel into the combustion chamber;
a fresh air feed for feeding fresh air into the combustion chamber of the at least one cylinder;
an exhaust gas discharge for discharging exhaust gas from the combustion chamber;
an exhaust gas recirculation for recirculating the exhaust gas discharged from the at least one cylinder into the combustion chamber, the exhaust gas recirculation fluidically communicating with the fresh air feed and the exhaust gas discharge;
a heat exchanger arranged in the exhaust gas recirculation, the heat exchanger including at least one first fluid path integrated into the exhaust gas recirculation and through which the exhaust gas to be recirculated is flowable, the heat exchanger further including at least one second fluid path, fluidically separated from the at least one first fluid path, through which the fuel is flowable;
wherein a knock number of the fuel is increased when the fuel flows through the heat exchanger; and
wherein the at least one second fluid path fluidically communicates with the at least one fuel injector.

2. The internal combustion engine according to claim 1, wherein the heat exchanger is a catalytic fuel evaporator for chemically converting the fuel flowing through the at least one second fluid path.

3. The internal combustion engine according to claim 1, further comprising a catalytic coating disposed in the at least one second fluid path.

4. The internal combustion engine according to claim 1, wherein the heat exchanger is configured to convert long-chain hydrocarbons contained in the fuel into short-chain hydrocarbons.

5. The internal combustion engine according to claim 1, wherein the heat exchanger configured to convert a hydrocarbon compound C₈H₁₈ into a hydrocarbon compound C₃H₈.

6. The internal combustion engine according to claim 1, wherein the heat exchanger is configured such that a chemical conversion of hydrocarbons contained in the fuel increases the knock number of the fuel by at least 2 RON.

7. The internal combustion engine according to claim 1, further comprising a fuel cooler arranged between the at least one second fluid path and the at least one fuel injector for cooling the fuel exiting the heat exchanger.

8. The internal combustion engine according to claim 7, wherein the fuel cooler is a second heat exchanger through which the fuel to be cooled and a coolant fluidically separated from the fuel are flowable, and wherein the coolant is thermally coupled to the fuel within the second heat exchanger for cooling of the fuel.

9. The internal combustion engine according to claim 1, further comprising an exhaust gas cooler arranged between the at least one first fluid path and the fresh air feed for cooling the exhaust gas exiting the heat exchanger.

10. The internal combustion engine according to claim 9, wherein the exhaust gas cooler is a second heat exchanger through which the exhaust gas to be cooled and a coolant fluidically separated from the exhaust gas are flowable, and wherein the exhaust gas is thermally coupled to the coolant within the second heat exchanger for cooling the exhaust gas.

11. A motor vehicle, comprising:
an internal combustion engine including:
at least one cylinder including a combustion chamber for combusting a fuel-air mixture introduced into the combustion chamber;
at least one fuel injector for injecting a fuel into the combustion chamber;
a fresh air feed for feeding fresh air into the combustion chamber of the at least one cylinder;
an exhaust gas discharge for discharging exhaust gas from the combustion chamber;
an exhaust gas recirculation for recirculating the exhaust gas discharged from the at least one cylinder into the combustion chamber, the exhaust gas recirculation fluidically communicating with the fresh air feed and the exhaust gas discharge;
a heat exchanger arranged in the exhaust gas recirculation, the heat exchanger including at least one first fluid path integrated into the exhaust gas recirculation and through which the exhaust gas to be recirculated is flowable, the heat exchanger further including at least one second fluid path fluidically separated from the at least one first fluid path through which the fuel is flowable;
wherein a knock number of the fuel is increased when the fuel flows through the heat exchanger; and
wherein the at least one second fluid path fluidically communicates with the at least one fuel injector.

12. The motor vehicle according to claim 11, further comprising:
a refrigeration system including a refrigeration circuit through which a refrigerant is flowable;
the refrigeration circuit including at least one of:
a fuel cooler for cooling the fuel exiting the heat exchanger; and
an exhaust gas cooler for cooling the exhaust gas exiting the heat exchanger;
wherein the refrigerant circuit is configured to cool at least one of (i) the fuel flowing through the fuel cooler and (ii) the exhaust gas flowing through the exhaust gas cooler.

13. The motor vehicle according to claim 12, further comprising an air conditioning system including the refrigeration system for air conditioning a vehicle interior.

14. The motor vehicle according to claim 11, wherein the heat exchanger is a catalytic fuel evaporator for chemically converting the fuel flowing through the at least one second fluid path.

15. The motor vehicle according to claim 11, further comprising a catalytic coating disposed in the at least one second fluid path.

16. The motor vehicle according to claim 11, wherein the heat exchanger is configured to convert long-chain hydrocarbons contained in the fuel into short-chain hydrocarbons.

17. The motor vehicle according to claim 11, wherein the heat exchanger is configured such that a chemical conversion of hydrocarbons contained in the fuel increases the knock number of the fuel by at least 2 RON.

18. The motor vehicle according to claim 12, wherein the fuel cooler is a second heat exchanger through which the fuel to be cooled and the refrigerant, fluidically separated from the fuel, are flowable, and wherein the refrigerant is thermally coupled to the fuel within the second heat exchanger for cooling of the fuel.

19. The motor vehicle according to claim 12, wherein the exhaust gas cooler is a second heat exchanger through which the exhaust gas to be cooled and the refrigerant, fluidically separated from the exhaust gas, are flowable, and wherein the refrigerant is thermally coupled to the exhaust gas within the second heat exchanger for cooling the exhaust gas.

20. An internal combustion engine for a motor vehicle, comprising:
at least one cylinder including a combustion chamber for combusting a fuel-air mixture introduced into the combustion chamber;
at least one fuel injector for injecting a fuel into the combustion chamber;
a fresh air feed for feeding fresh air into the combustion chamber of the at least one cylinder;
an exhaust gas discharge for discharging exhaust gas from the combustion chamber;
an exhaust gas recirculation for recirculating the exhaust gas discharged from the at least one cylinder into the combustion chamber, the exhaust gas recirculation fluidically communicating with the fresh air feed and the exhaust gas discharge;
a heat exchanger arranged in the exhaust gas recirculation, the heat exchanger including at least one first fluid path integrated into the exhaust gas recirculation and through which the exhaust gas to be recirculated is flowable, the heat exchanger further including at least one second fluid path, fluidically separated from the at least one first fluid path, through which the fuel is flowable;
a fuel cooler arranged between the at least one second fluid path and the at least one fuel injector for cooling the fuel exiting the heat exchanger;
an exhaust gas cooler arranged between the at least one first fluid path the fresh air feed for cooling the exhaust gas exiting the heat exchanger;
wherein a knock number of the fuel is increased when the fuel flows through the heat exchanger; and
wherein the at least one second fluid path fluidically communicates with the at least one fuel injector.
